(19) United States
(12) Patent Application Publication
(10) Pub. No.: US 2022/0129990 A1
(43) Pub. Date: Apr. 28, 2022

(54) MULTIDIMENSIONAL ASSESSMENT OF CYBER SECURITY RISK

(71) Applicant: BLACKPANDA PTE. LTD., Singapore (SG)

(72) Inventor: Dominique Roudaut, London (GB)

(21) Appl. No.: 17/513,854

(22) Filed: Oct. 28, 2021

Related U.S. Application Data
(60) Provisional application No. 63/106,773, filed on Oct. 28, 2020.

(51) Int. Cl. G06Q 40/08; H04L 29/06

(52) U.S. Cl. CPC G06Q 40/08; H04L 63/20

(57) ABSTRACT

Methods and systems describe providing for the multidimensional assessment and management of cyber risk. First, a digital cyber risk agent is deployed to a number of end points associated with a client. The cyber risk agent is configured to access the end points for cyber risk based on a detection of a number of cyber risk factors along multiple dimensions at the end points. Second, a risk score is generated for each cyber risk factor detected at the end points. Third, the risk score is aggregated for the cyber risk factors to generate an overall risk score for the client. Finally, the system modifies a base insurance premium based on the overall score.

### CROSS-REFERENCE TO RELATED APPLICATIONS

This application claims the benefit of U.S. Provisional Patent Application No. 63/106,773, filed Oct. 28, 2020, which is hereby incorporated by reference in its entirety.

### FIELD OF THE INVENTION

The present invention relates generally to the field of cyber security, and more particularly to systems and methods for providing intelligent, multidimensional assessment of cyber security risk.

### BACKGROUND

Cyber security risk (“cyber risk”) is among the most significant issues companies face today. In a list of the top five risks identified by the World Economic Forum in 2019, massive incidents of data fraud/theft and large scale cyberattacks were #4 and #5, respectively. Despite the significance and financial impact of cyber risk, it remains overwhelmingly uninsured. In 2016, the impact of cyberattacks on the United States economy reached between 0.3% and 0.6% of the Gross Domestic Product (GDP). Less than 1% of those losses were insured, compared with 50% of losses arising from natural catastrophes.

The main challenge of cyber risk is its systematic underinsurance. Some economists estimate that cybercrime is predicted to cost the world $6 trillion annually by 2021, while a more conservative estimate from the Economist suggests $1.6 trillion, i.e., the GDP of Russia, the thirteenth highest GDP in the world.

Underinsurance of cyber risk can be explained both on the offer and demand side of the market. On the demand side, a lack of awareness and urgency may contribute to a lack of demand for insurance. On the supply side, the complexity of insuring for cyber risk, as well as a lack of expertise from underwriters, may contribute to a lack of offerings for insurance in the market. Many underwriters are knowledgeable about financial lines insurance, but less so about the technical aspects underlying cyber risk and how to properly assess it.

Currently to assess the cyber risk of a corporation, an underwriter will typically submit an application form containing between 5 to 15 questions. This application form only covers a general overview of the risk while grasping neither its entirety nor its depth.

Thus, there is a need in the field of cyber security to create a new and useful system and method for assessing cyber security risk in a multidimensional way. The source of the problem, as discovered by the inventors, is a lack of assessment and management of cyber risk in a way that encompasses the width as well as breadth of potential risk vectors along multiple dimensions in a comprehensive way that provides insight to both the insured and the insurer.

### SUMMARY

The systems and methods described herein provide for the multidimensional assessment and management of cyber risk.

First, a digital cyber risk agent is deployed to a number of end points associated with a client. The cyber risk agent is configured to access the end points for cyber risk based on a detection of a number of cyber risk factors along multiple dimensions at the end points. Second, a risk score is generated for each cyber risk factor detected at the end points. Third, the risk score is aggregated for the cyber risk factors to generate an overall risk score for the client. Finally, the system modifies a base insurance premium based on the overall score.

In some embodiments, the risk score factors are built around multiple dimensions of cyber exposure assessment. Such dimensions may include one or more of: assessment of the organization's defensive cyber security perimeter; an organization's ability to monitor the exfiltration of data and its internal handling, i.e., data behavior; assessment of threat intelligence, including monitoring of open and dark web activity for early threat detection; compliance and regulatory assessment, including an organization's compliance with relevant data and privacy laws or regulations; and human risk assessment, including the risk pertaining to employees.

In some embodiments, if the system detects a data breach at one or more of the end points while the cyber risk agent is deployed at the end points, one or more post-breach incident response recommendations can be provided to the client.

In some embodiments, a user interface (“UI”) dashboard is provided for display on a client device. The UI dashboard can display at least the aggregated risk score of the client.

In some embodiments, one or more recommended actions can be provided based on the assessment of the end points and the aggregated risk scores.

Further areas of applicability of the present disclosure will become apparent from the detailed description, the claims and the drawings. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIG. 1A is a diagram illustrating an exemplary environment in which some embodiments may operate.

FIG. 1B is a diagram illustrating an exemplary computer system that may execute instructions to perform some of the methods herein.

FIG. 2 is a flow chart illustrating an exemplary method that may be performed in some embodiments.

FIG. 3A is a diagram illustrating one example embodiment of a cyber risk assessment, in accordance with some embodiments.

FIG. 3B is a diagram illustrating one example embodiment of base insurance premium data, in accordance with some embodiments.

FIG. 3C is a diagram illustrating one example embodiment of an aggregate risk score displayed on a user interface dashboard, in accordance with some embodiments.

FIG. 3D is a diagram illustrating one example embodiment of a cyber risk assessment along a dimension of cyber security perimeter defensiveness, in accordance with some embodiments.

FIG. 3E is a diagram illustrating another example embodiment of a cyber risk assessment along a dimension of cyber security perimeter defensiveness, in accordance with some embodiments.

FIG. 3F is a diagram illustrating one example embodiment of a cyber risk assessment along a dimension of data exfiltration, in accordance with some embodiments.

FIG. 3G is a diagram illustrating one example embodiment of a cyber risk assessment along dimensions of early threat detection, compliance, and human risk assessment, in accordance with some embodiments.

FIG. 3H is a diagram illustrating one example embodiment of a cyber risk score provided in a user interface dashboard.

FIG. 3I is a diagram illustrating one example embodiment of visual information about cyber risk provided in a user interface dashboard.

FIG. 3J is a diagram illustrating one example embodiment of overall end point analysis provided in a user interface dashboard.

FIG. 3K is a diagram illustrating one example embodiment of individual end point analysis provided in a user interface dashboard.

FIG. 3L is a diagram illustrating one example embodiment of individual end point analysis with scoring provided in a user interface dashboard.

FIG. 4 is a diagram illustrating an exemplary computer that may perform processing in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

The presently described systems and methods provide for assessment of cyber risk profiles for organizations, companies, and other entities (collectively referred to as “clients” herein). A process is presented to analyse security configurations and policy in order to accurately determine cyber risk. Cyber insurance premiums can then be calculated based on this risk. Risk scores and risk data can be analysed across any given organization, or across industry segments, geographic regions, trends, or any other suitable context. The procedure follows industry-accepted best practices for configuring many different types of systems and platforms and enhancing the security of an enterprise or organization. This process can be used by, for example, business owners and/or system administrators of organizations to understand their environment from a unique perspective and make more informed decisions.

In some embodiments, the cyber risk assessments can be performed in real time or substantially near real time. In some embodiments, data is collected through a combined process of one or more of: cyber risk agents deployed to end points, policy and procedure analysis, and/or audit and open source information. In some embodiments, the assessments provide strategic recommendations for risk reduction. In various embodiments, the risk assessment process and methodology includes analysis of multiple dimensions of cyber exposure to identity and assess the robustness of one or more of security infrastructure, behavior of critical data, threat intelligence, regulatory compliance, and the human risk of organizations. This approach has the benefit of being able to encompass both offensive and defensive practices, both technological assessments and human risk assessments, and analysis of wide-ranging data in various uses and contexts. Insurance underwriters can also benefit from these and other aggregated inputs to best assess and modify insurance premiums for cyber risk.

In various embodiments, relevant assessments may include assessing and scoring risk factors down to the end points of clients; assessing and scoring risk for the entire cyber ecosystem down to third parties; assessing and scoring cyber hygiene on multiple access points, including, e.g., the Internet of Things (“IoT”), mobile infrastructure, and cloud infrastructure residing on top of computer networks; and assessing and scoring cyber exposure at various levels.

In various embodiments, the cyber risk assessment also encompasses the whole chain of risk, from prevention to mitigation to risk transfer. In some embodiments, at every moment of the risk chain, a solution can be presented to mitigate and prevent cyber losses and client exposure. In addition, insights can be offered to both the insured and the insurer, providing them both with the same transparent information regarding cyber risk. Offensive and preventative measures can also be implemented as part of the assessment process, including early threat detection, insider threat detection, and training clients to raise their awareness of best practices and to build a human firewall against cyber security vulnerabilities.

In various embodiments, this comprehensive cyber risk assessment and management process can include some or all of the following. First, a digital cyber risk agent can be deployed by a client on its end points in order to check and assess for several risk factors in real time or near real time, which is a far better assessment than the relatively few questions asked once a year by insurance companies. The cyber risk agent can be deployed to various end points such as, e.g., computers, mobile phones, IoT devices, networks, and cloud-based locations associated with a client and/or third parties relevant to the client. Second, the system can compile the risk analysis identified through this end point analysis. It can apply an algorithm to deliver a score to each detected risk factor, then aggregate these scores to provide an overall risk score depicting in near real time a client's cyber exposure. In some embodiments, that score is used by the system to modify a base insurance premium. In some embodiments, this modification takes into account loadings, i.e., additional costs built into the insurance policy to cover losses which are higher than anticipated due to a client being prone to high risk, as well as discounts for the insurance premium, in order to best reflect the reality of the client's cyber exposure. In some embodiments, such adjustments can be made in near real time, or at specified time intervals (e.g., yearly upon renewal).

In some embodiments, data is collected from one or more sources or established databases to refine this risk pricing. Such data can be complemented by manually inputted data from one or more insurance underwriters, market data, digital forensics incident response experts, or other sources.

In some embodiments, a user interface can provide for a cyber risk monitoring dashboard, which can be built as a command center for a client. The dashboard includes key pieces of information and multiple levels of detail, and includes at least an aggregated risk score of the client along multiple dimensions. In some embodiments, the system also provides one or more recommendations for a client to implement in order to improve cyber resilience and thereby reduce cyber risk insurance premiums.

I. Exemplary Environments

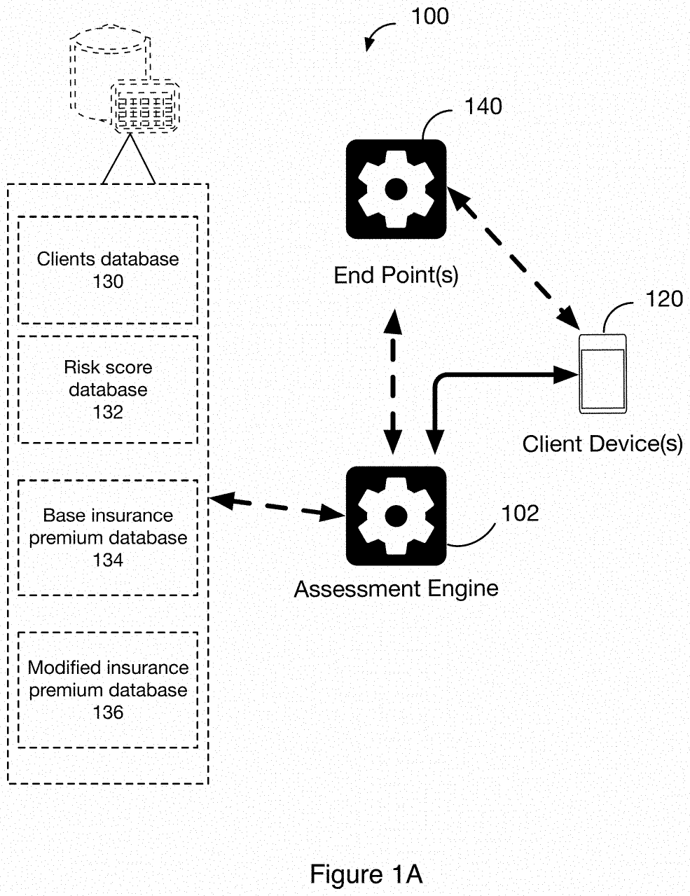

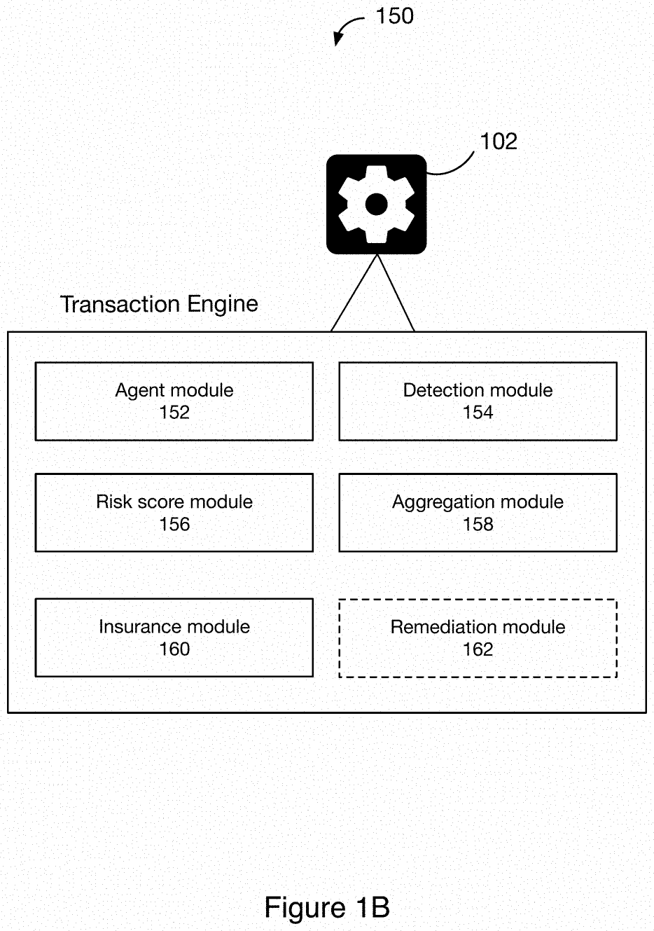

FIG. 1A is a diagram illustrating an exemplary environment in which some embodiments may operate. In the exemplary environment 100, one or more client device(s) 120 are connected to an assessment engine 102 and, optionally, one or more client end point(s) 140. The assessment engine 102 is optionally connected to one or more end point(s) 140, and optionally connected to one or more repositories and/or databases, including, e.g., a clients database 130, risk score database 132, base insurance premium database 134, and/or a modified insurance premium database 136. One or more of the databases may be combined or split into multiple databases. The client device 120 in this environment may be a computer, and the assessment engine 102 may be an application or software hosted on a computer or multiple computers which are communicatively coupled via remote server or locally.

The exemplary environment 100 is illustrated with only one client device, one assessment engine, and one end point, though in practice there may be more or fewer client devices, assessment engines, and/or end points. In some embodiments, the client devices, assessment engines, and/or end points may be part of the same computer, device, or network.

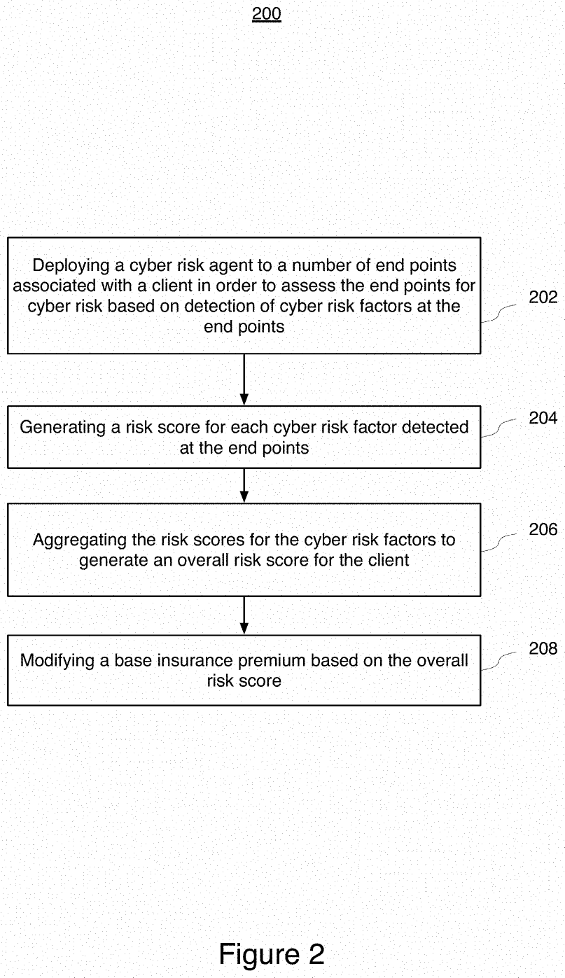

In an embodiment, the assessment engine 102 may perform the method 200 (FIG. 2A) or other method herein and, as a result, provide assessment of cyber risk. In some embodiments, the assessment engine 102 may further provide modifications of insurance premiums based on the assessment of cyber risk. In some embodiments, the assessment engine 102 may generate information to be displayed on a user interface dashboard on a client device. In some embodiments, the assessment engine 102 may provide one or more recommendations, strategies, or remediation activities for a client to reduce its cyber risk profile. In some embodiments, the assessment engine 102 is in communication with one or more of the client device(s), end point(s), and/or other applications or devices over a network. In some embodiments, an application server and/or some other network server may facilitate this communication. In some embodiments, the assessment engine 102 is in whole or in part an application, browser extension, or other piece of software hosted on a computer or similar device, or is itself a computer or similar device configured to host an application, browser extension, or other piece of software to perform some of the methods and embodiments herein.

Client device(s) 120 are devices with a display configured to present information to a user of the device and send or receive data on behalf of the user of the device. In some embodiments, the client and/or one or more representatives of the client are the user of the client device 120. In some embodiments, the client device 120 presents information in the form of a user interface (UI) with UI elements or components, such as a UI “dashboard” containing information and reports which a user may opt to explore in greater detail. In some embodiments, the client device 120 sends and receives signals and/or information to the assessment engine 102 and/or end point(s) 140. In some embodiments, the client device 120 is a computing device capable of hosting and executing one or more applications or other programs capable of sending and/or receiving information. In some embodiments, the client device 120 may be a computer desktop or laptop, mobile phone, virtual assistant, virtual reality or augmented reality device, wearable, or any other suitable device capable of sending and receiving information. In some embodiments, the assessment engine 102 140 may be hosted in whole or in part as an application or web service executed on the client device 120. In some embodiments, one or more of the end point 140, assessment engine 102, and/or client device 120 may be the same device.

The end point(s) 140 are networked computers or other devices which a client may use to perform various activities. In various embodiments, an end point may be, e.g., a computer, mobile phone, IoT-based device, network, network server or device, cloud server or cloud-based device, or any other suitable device used by the client. In some embodiments, end point(s) may be used or owned by third parties to perform activities relevant to or associated with the client.

In some embodiments, optional repositories can include one or more of a clients database 130, risk score database 132, base insurance premium database 134, and/or modified insurance premium database 136. The optional clients database 130 functions to store and/or maintain client account data associated with a client, including information related to the client's end points and risk profile data. The optional risk score database 132 functions to store and/or maintain risk scores for clients along with risk factors associated with those clients. The optional base insurance premium database 134 functions to store and/or maintain information related to base insurance premiums for various industries. The optional modified insurance premium database 136 functions to store and/or maintain modified insurance premiums which have been generated by the system. The optional database(s) may also store and/or maintain any other suitable information for the assessment engine 102 to perform elements of the methods and systems herein. In some embodiments, the optional database(s) can be queried by one or more components of system 100 (e.g., by the assessment engine 102), and specific stored data in the database(s) can be retrieved.

FIG. 1B is a diagram illustrating an exemplary computer system 150 with software modules that may execute some of the functionality described herein.

Agent module 152 functions to deploy or verify a client's deployment of a digital cyber risk agent to one or more of the client's end points.

Detection module 154 functions to assess cyber risk for the end points and detect risk score factors present at those end points.

Risk score module 156 functions to determine risk scores for the client based on the detected risk score factors.

Aggregation module 158 functions to aggregate risk scores to generate an overall risk score for a client.

Insurance module 160 functions to modify base insurance premiums based on the overall risk score for the client.

Optional remediation module 162 functions to provide one or more remediation activity recommendations to the client.

The above modules and their functions will be described in further detail in relation to the exemplary methods below.

II. Exemplary Method

FIG. 2 is a flow chart illustrating an exemplary method that may be performed in some embodiments.

At step 202, the system deploys or verifies deployment of cyber risk agent(s) to a number of end points associated with a client in order to assess the end points for cyber risk based on detection of cyber risk factors at the end points. In some embodiments, a client may provide the system with the ability to deploy cyber risk agents at one or more of the client's end points. In additional or alternative embodiments, the client may deploy cyber risk agents at the client's end points by itself, and send notification to the system or otherwise provide the system with the ability to verify deployment. In some embodiments, the cyber risk agent is a lightweight agent installed on each endpoint. In some embodiments, the end point is a device managed by the system, with the agent executing unnoticeably in the background operation of the end point without impacting users. Such lightweight cyber risk agents may consist of minimal code and a small file size, leading to the ability for the agent to perform efficiently and invisibly within the environment.

In some embodiments, the cyber risk agent or agents are configured to assess the end points for cyber risk based on detection of cyber risk factors at the end points. In some embodiments, a predefined list of potential risk score factors is used by the cyber risk agent and checked against with respect to the end points to identify the presence of each risk score factor. In some embodiments, this assessment is based on collected data from the end points being compared against known good configurations and policy requirements for the given end points. In some embodiments, the client may provide a set of risk metrics for an endpoint to the system, which can be used by the system to assess the end points.

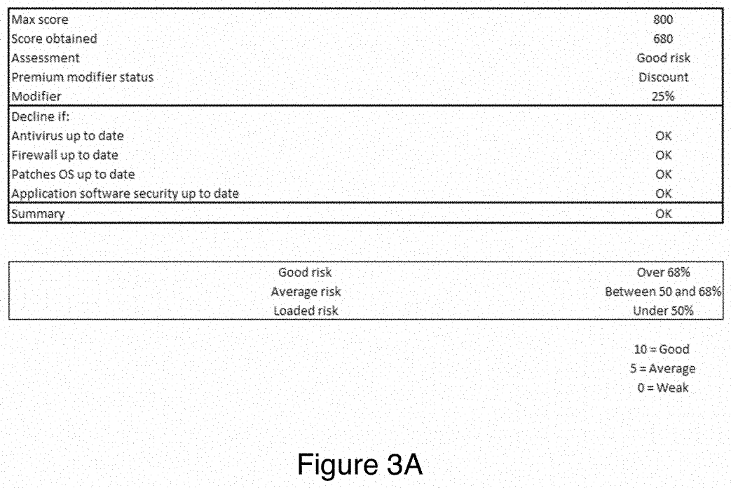

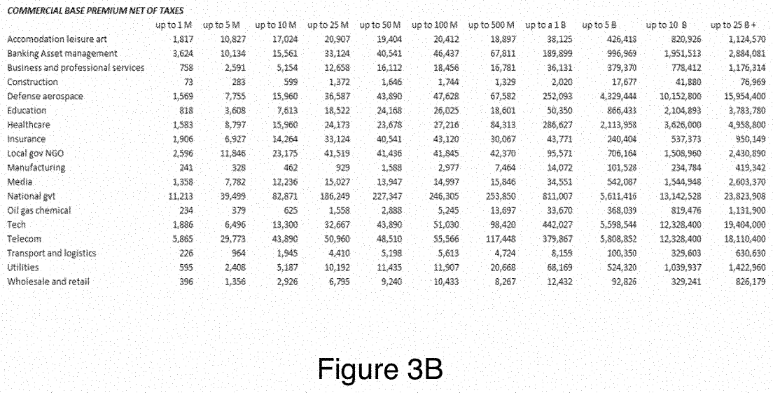

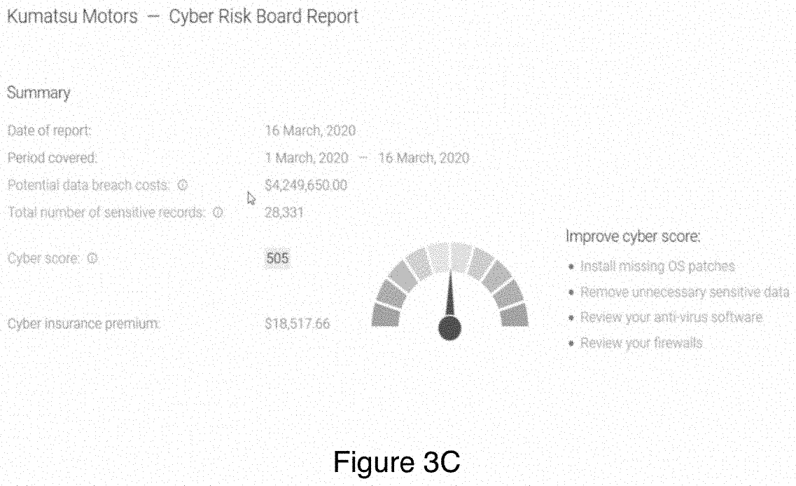

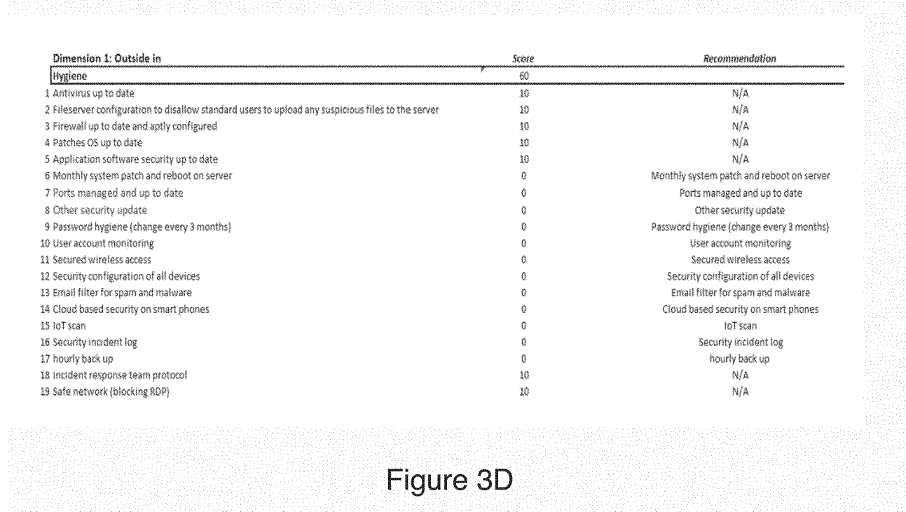

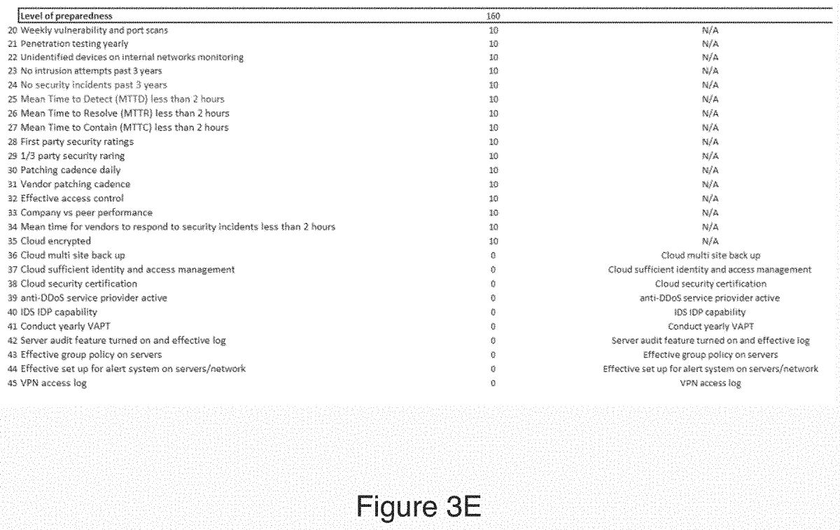

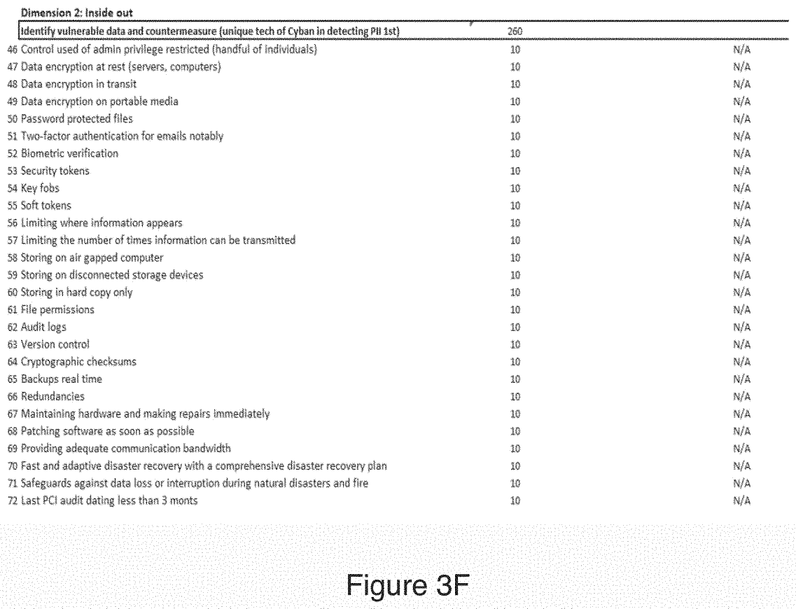

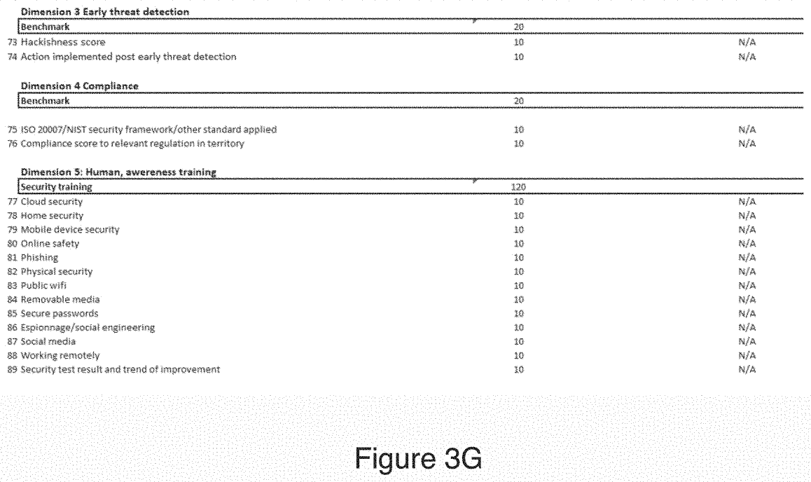

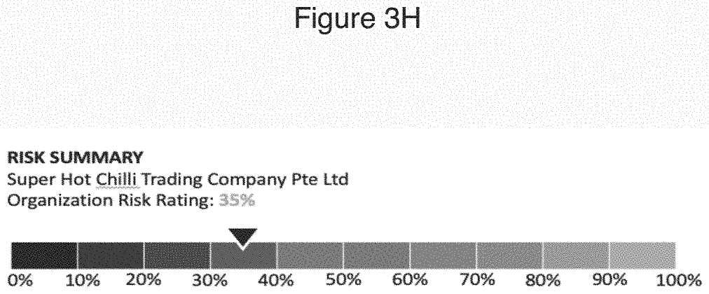

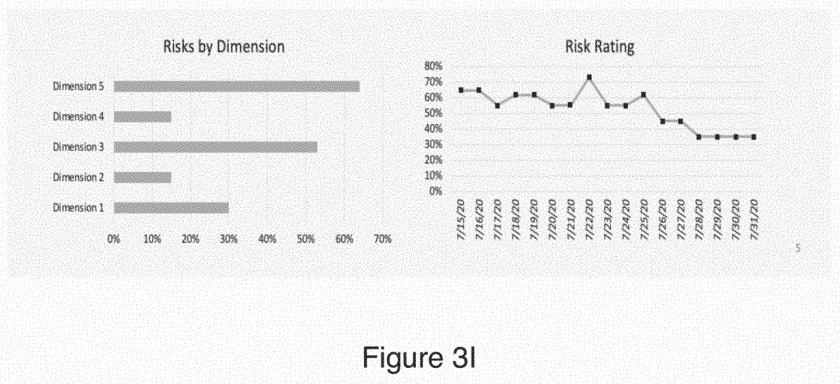

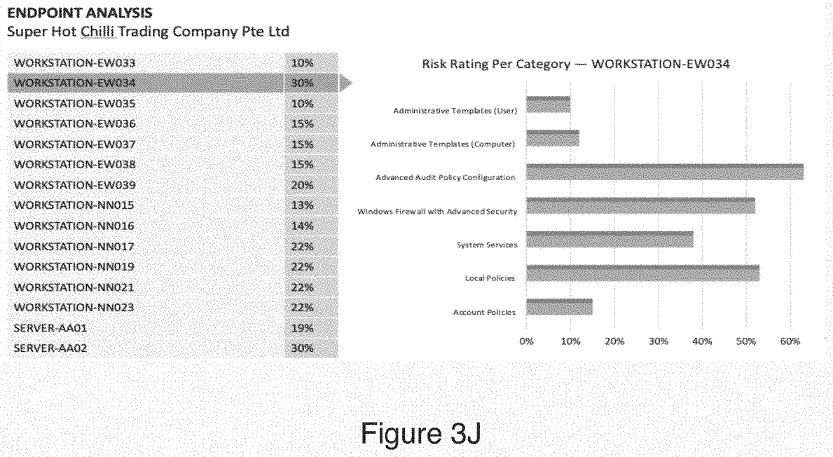

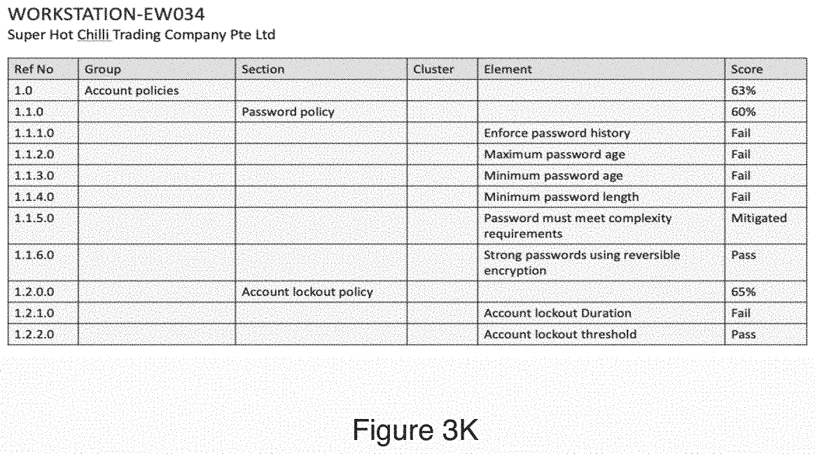

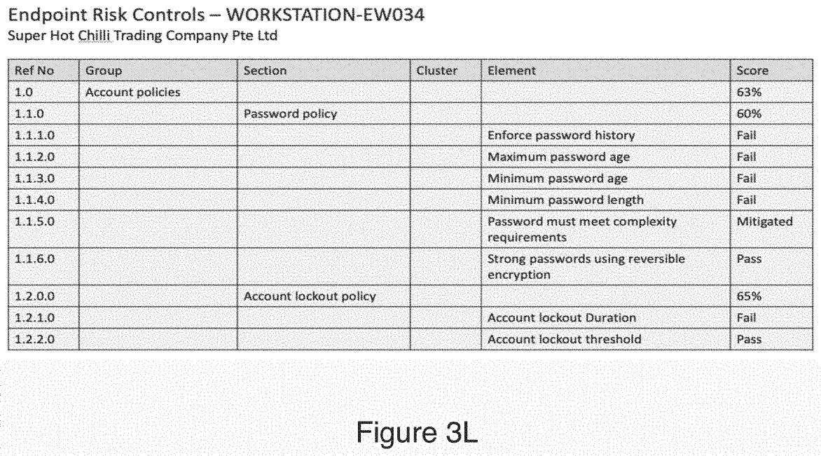

In some embodiments, the risk score factors may include aspects of cyber security hygiene at the end point. This may include, for example: whether the antivirus software is up to date, fileserver configurations to disallow standard users to upload any suspicious files to the server, whether the firewall is up to date and aptly configured, whether the operating system is up to date, whether password hygiene is being followed (including, e.g., password changes every 3 months), whether secured wireless access is provided, whether email is being filtered for spam and/or malware, whether security incident logs are provided, whether hourly backups of data have been established, whether the incident response team has a protocol in place, and more. A list of some potential risk factors can be found in the provided example of FIG. 3D.

In some embodiments, the risk score factors can include aspects of the level of preparedness of a client for various cyber security risks. This may include, for example: weekly vulnerability and port scans, penetration testing performed annually, cloud encryption of data, multi-site backup of data, server audit features being enabled, effective group policy on servers, VPN access logs, history of intrusion attempts, and more. A list of some potential risk factors can be found in the provided example of FIG. 3E.

In some embodiments, the risk score factors can include aspects of the organization's ability to monitor the exfiltration of data (i.e., data leaving the client in various ways) and the ability to internally handle employee and third party behavior around data. This may include, for example: administrator privileges being restricted to a handful of individuals, data encryption in transit, data encryption on portable media, data encryption when servers or computers are not being used, password protected files, multi-factor authentication, usage of security tokens, file permissions, audit logs, version control, backups being made in real time, redundancies, hardware maintenance, and more. A list of some potential risk factors can be found in the provided example of FIG. 3F.

In some embodiments, the risk score factors can include aspects of early threat detection, compliance with data laws and privacy regulations, and/or human risk assessments and training, including, e.g., training in cloud security, home security, mobile device security, phishing attacks, public wi-fi, social media, secure passwords, and working remotely. A list of some potential risk factors can be found in the provided example of FIG. 3G.

At step 204, the system generates a risk score for each cyber risk factor detected at the end points. In some embodiments, the risk score will be determined differently for each cyber risk factor, with separate criterion for how the scores are calculated. In some embodiments, an overarching scoring policy may be implemented, such as all scores falling within a 0-10 range.

An example of one risk score determination is provided in FIG. 3A. In the example, this risk score is not a risk rating, since it does not provide a likelihood of risk nor a severity level of the risk, only a risk assessment. However, in some embodiments, a risk rating can be provided alternatively to or in addition to a risk score. In the example, a max score of 800 is calculated for a maximum best score achievable, and an obtained score of 680 is calculated as the client's score for that end point. An assessment is provided, and checks for whether components are up to do, including a firewall, antivirus software, and more. The assessment is calculated as “good risk”, i.e., over 68% of a score has been obtained. The system thus deems this end point to have a good risk score and to be relatively low risk. Definitional scores for good risk, average risk, and loaded (i.e., high) risk are provided.

In some embodiments, human risk assessment can be additionally performed. First, the system captures cyber risk data pertaining to one or more employees of the client from a number of sources, which may be internal sources, external sources, or a combination of the two. The human risk assessment is then determined based on the captured cyber risk data pertaining to the employee. In some embodiments, the cyber risk data can pertain to one or more employees grouped into one or more of, e.g., individual, location, team, and department categories. Many such categories may be contemplated.

In some embodiments, one or more Artificial Intelligence (“AI”) algorithms may be employed to calculate these risk scores based on the data collected by the deployed cyber risk agent and other received data. For example, Machine Learning (“ML”) techniques and procedures may be implemented. ML algorithms may be trained on the collected data, detected risks and risk score factors, and a corpus of end point data, previous calculated scores, detected risk factors for end points, and more.

At step 206, the system aggregates the risk scores for the cyber risk factors to generate an overall risk score for the client. Once the risk scores for the risk factors are individually calculated, they are summed up to determine a risk score for each of the end points. This in turn is summed up or otherwise aggregates to determine an overall risk score for all end points, which effectively becomes an overall risk score for the client. The previous example provided by FIG. 3A shows this overall risk score as the “score obtained” of 680.

At step 208, the system modifies a base insurance premium based on the overall risk score. A base insurance premium can be received or determined in a number of ways. Insurance pricing comes from the combination of the base premium and one or more determined premium modifiers.

In some embodiments, a predefined list of base insurance premiums is used by the system to receive the relevant base insurance premium for the client. The list may come from an insurance provider, The list can be sorted according to, e.g., commercial industry,

In some embodiments, a base premium can be determined by receiving data from various sources, and using the data to determine a frequency and severity of cyber losses across various industries. In some embodiments, these cyber losses can be determined based on revenue band and industry or activity (i.e., tech, manufacturing, media, or transport and logistics). An example of such determined, or received, base insurance premiums is provided in FIG. 3B. The chart illustrates commercial base insurance premiums based on revenue band and severity of cyber losses in that particular industry or activity. For example, for a tech company with revenue between $5 million and $10 million per year, the cyber risk losses may be such that an insurance premium is determined to be $13,300 per year. A base insurance premium is then modified via one or more modifiers as a result of the risk score of the client determined in previous steps.

In some embodiments, the base insurance premium is modified to be increased or decreased based on the overall risk score of the client. If the overall risk score was loaded, for example, then the insurance premium will be modified to be increased. Conversely, if the client has a good risk score, then the insurance premium receives a discount. In most cases, an insurance premium won't be calculated directly from the risk score, since it is a complicated calculation that involves factors beyond the risk factors used by the system. However, in some embodiments, this direct premium calculation is achieved. In other embodiments, an insurance premium may come from an insurance company or underwriter, who may be using the system in some capacity. That insurance premium can be adjusted based on the risk scoring and assessment. In some embodiments, to ensure that the insurance customer doesn't receive a drastically different premium (which could lead to the customer deciding to leave the insurance company, for example), the system sets a base, and then discounts from that base. So in one example, a discount of 20% to 30% may be given for a good risk score, but no increase of premium is given for an average or loaded risk score.

In some embodiments, this modification of the base insurance premium can be calculated in real time or substantially real time as end points operate. For example, a lightweight cyber risk agent deployed to an end point may be detecting and assessing various risk score factors and scoring them in the background constantly. This leads to individual risk score factors being rescored on a constant or frequent periodic basis, which in turn leads to overall end point risk scores and client risk scores being readjusted. This can all occur in real or substantially real time. In some embodiments, a risk score may be able to change every 5 minutes or less. In some embodiments, risk scores are calculated at set intervals, such as weekly, daily, or monthly, or yearly upon an insurance policy renewal.

In some embodiments, a request is received for the modified or unmodified base insurance premium from one or more third parties. For example, an insurance underwriter may make a request. The information can be provided to the third parties in various contexts. In some embodiments, the information will be provided only upon the client expressly agreeing to the disclosure. In some embodiments, no express permission is necessary. In some embodiments, authentication of the third party within the system is necessary prior to providing the information.

In some embodiments, upon deploying or verifying deployment of the cyber risk agent to an end point, the system may detect a data breach at one or more of the end points of the client. In response to detecting the breach, the system can provide one or more post-breach incident response recommendations. In some embodiments, no breach is discovered, but the system can still provide one or more remediation activity recommendations to increase security. One example of such remediation activity recommendations is shown with respect to FIG. 3C. This figure illustrates an example user interface dashboard for a client, Komatsu Motors, showing an overall or aggregated risk score for the client, 505, as well as a modified base insurance premium of $18,517.66. A figure of potential data breach costs is provided, totaling over $4 million. A graphic depicts the cyber score rating classification, which is squarely in the “average risk score” category. On the right, a number of remediation activity recommendations are provided, including recommendations to install missing operating system patches, remove unnecessary sensitive data, review anti-virus software, and review firewalls.

As can be seen in FIG. 3C, the system can provide for a user interface (UI) dashboard which displays at least the aggregated risk score for the client. In some embodiments, much more detail can be viewed by the client, at an increasingly granular level as the client desires or opts to access through navigating the dashboard. Dashboard information can be provided to the client at varying degrees of granularity, including risk score factors, risk scores, and remediation activity recommendations to improve the scores, if applicable.

In some embodiments, as illustrated by the examples in FIGS. 3H-L, the dashboard can help the client drill down to the end point level by indicating which particular end points are at risk, and which risk factors apply to them. Remediation activity recommendations are also available at the individual end point level.

FIG. 3H illustrates an example of a UI dashboard element showing a risk rating for a company. The risk rating is 35%, and a position on a scale shows the risk rating visually. In some embodiments, the risk score can be updated in real time or substantially near real time (e.g., it can be configured to be updated every 5 minutes for most risk factors). In some embodiments, this visual scale can allow for the position of the slider to shift in real time as a risk score changes.

FIG. 3I illustrates an example of a UI dashboard element showing a chart of risks by dimension, and a graph of risk rating over time. The dimensions may refer to the multiple dimensions for risk factors described above (e.g., threat intelligence, exfiltration of data, human risk assessment, cyber security perimeter defense, and compliance and regulatory assessment).

FIG. 3J illustrates an example of a UI dashboard element showing an overall endpoint analysis screen. The screen shows a list of individual end points (the “workstations” listed) along with a percentage relating to the obtained risk score (as part of maximum risk score) for that end point. On the right, a chart shows a risk rating per category for a selected end point, including local and account policies, system services, and more.

FIG. 3K illustrates an example of a UI dashboard element showing an individual risk factor group and two risk factors within that group, as applied to a single end point (Workstation-EW034). The client can additionally see individual elements which make up those risk factors, such as maximum password age, minimum password age, whether the password meets complexity requirements, and more. As such, a large amount of granular detail is accessible.

FIG. 3L, similar to FIG. 3K, illustrates an example of a UI dashboard element showing an individual risk factor group and two risk factors within that group. However, an additional score is provided for each single granular element making up the risk score factors. Thus, a client can receive a very clear picture of the strengths and weaknesses of individual end points, down to specific elements of risk factors.

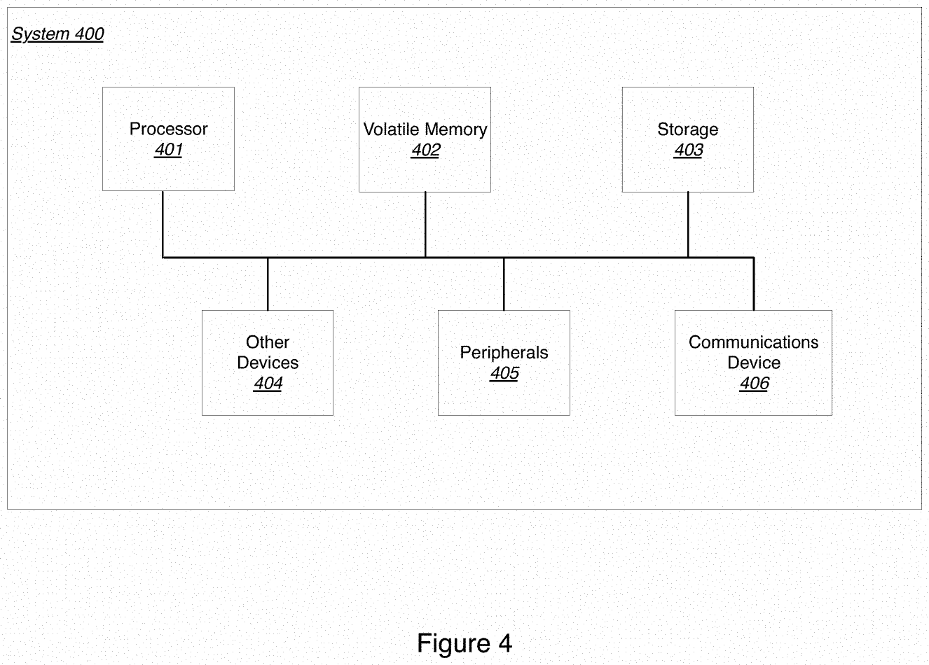

FIG. 4 is a diagram illustrating an exemplary computer that may perform processing in some embodiments. Exemplary computer 400 may perform operations consistent with some embodiments. The architecture of computer 400 is exemplary. Computers can be implemented in a variety of other ways. A wide variety of computers can be used in accordance with the embodiments herein.

Processor 401 may perform computing functions such as running computer programs. The volatile memory 402 may provide temporary storage of data for the processor 401. RAM is one kind of volatile memory. Volatile memory typically requires power to maintain its stored information. Storage 403 provides computer storage for data, instructions, and/or arbitrary information. Non-volatile memory, which can preserve data even when not powered and including disks and flash memory, is an example of storage. Storage 403 may be organized as a file system, database, or in other ways. Data, instructions, and information may be loaded from storage 403 into volatile memory 402 for processing by the processor 401.

The computer 400 may include peripherals 405. Peripherals 405 may include input peripherals such as a keyboard, mouse, trackball, video camera, microphone, and other input devices. Peripherals 405 may also include output devices such as a display. Peripherals 405 may include removable media devices such as CD-R and DVD-R recorders/players.

Communications device 406 may connect the computer 100 to an external medium. For example, communications device 406 may take the form of a network adapter that provides communications to a network. A computer 400 may also include a variety of other devices 404. The various components of the computer 400 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method for intelligent assessment and management of cyber risk, the method comprising:
deploying or verifying deployment of a cyber risk agent to a plurality of end points associated with a client, wherein the cyber risk agent is configured to assess the end points for cyber risk based on detection of a plurality of cyber risk factors at the end points;
generating a risk score for each cyber risk factor detected at the end points;
aggregating the risk scores for the cyber risk factors to generate an overall risk score for the client; and
modifying a base insurance premium based on the overall risk score.

2. The method of claim 1, further comprising:
receiving additional cyber risk data pertaining to the end points;
generating one or more additional risk scores based on the additional cyber risk data;
re-aggregating the risk scores for the cyber risk factors based on at least the one or more additional risk scores; and
modifying the base insurance premium based on the re-aggregated risk scores.

3. The method of claim 1, further comprising:
upon deploying the cyber risk agent, detecting a data breach at one or more of the end points of the client;
in response to detecting the data breach, providing one or more post-breach incident response recommendations.

4. The method of claim 1, further comprising:
providing, for display on a client device, a user interface (UI) dashboard, wherein the UI dashboard displays at least the aggregated risk score of the client.

5. The method of claim 1, further comprising:
providing, to the client device, one or more recommended actions based at least on the assessment of the end points and the aggregated risk scores.

6. The method of claim 1, further comprising:
determining the base premium by calculating cyber risk losses based on revenue band and activity.

7. The method of claim 1, wherein the modifying of the base premium comprises:
determining a modifier of the base premium based on the overall risk score.

8. The method of claim 1, further comprising:
capturing cyber risk data pertaining to one or more employees of the client; and
determining a human risk assessment for the client based on the captured cyber risk data pertaining to the employees.

9. The method of claim 8, wherein the cyber risk data pertaining to the one or more employees is grouped into one or more of: individual, location, team, and department categories.

10. The method of claim 1, further comprising:
providing the modified base insurance premium in response to a request for the base insurance premium from one or more third parties.

11. The method of claim 10, wherein the modified base insurance premium is provided in real or substantially real time in response to the request for the base insurance premium from the one or more third parties.

12. The method of claim 1, wherein assessing the cyber risk for the end points comprises analysis of the security configuration and policy of each of the end points.

13. The method of claim 12, wherein assessing the cyber risk for the end points comprises comparing the security configuration and policy of each of the end points to risk metrics calculated from a plurality of known good configurations and policies.

14. A non-transitory computer-readable medium containing instructions for intelligent assessment and management of cyber risk, comprising:
instructions for deploying or verifying deployment of a cyber risk agent to a plurality of end points associated with a client, wherein the cyber risk agent is configured to assess the end points for cyber risk based on detection of a plurality of cyber risk factors at the end points;
instructions for generating a risk score for each cyber risk factor detected at the end points;
instructions for aggregating the risk scores for the cyber risk factors to generate an overall risk score for the client; and
instructions for modifying a base insurance premium based on the overall risk score.

15. The non-transitory computer-readable medium of claim 14, further comprising:
instructions for receiving additional cyber risk data pertaining to the end points;
instructions for generating one or more additional risk scores based on the additional cyber risk data;
instructions for re-aggregating the risk scores for the cyber risk factors based on at least the one or more additional risk scores; and
instructions for modifying the base insurance premium based on the re-aggregated risk scores.

16. The non-transitory computer-readable medium of claim 14, further comprising:
upon deploying the cyber risk agent, instructions for detecting a data breach at one or more of the end points of the client;
in response to detecting the data breach, instructions for providing one or more post-breach incident response recommendations.

17. The non-transitory computer-readable medium of claim 14, further comprising:
instructions for providing, for display on a client device, a user interface (UI) dashboard, wherein the UI dashboard displays at least the aggregated risk score of the company.

18. The non-transitory computer-readable medium of claim 14, further comprising:
instructions for providing, to the client device, one or more recommended actions based on one or more of the assessment of the end points and the aggregated risk scores.

19. The non-transitory computer-readable medium of claim 14, further comprising:
instructions for determining the base premium by calculating cyber risk losses based on revenue band and activity.

20. The non-transitory computer-readable medium of claim 14, wherein the modifying of the base premium comprises:
instructions for determining a modifier of the base premium based on the overall risk score.
